(19) United States
(12) Patent Application Publication
(10) Pub. No.: US 2014/0365412 A1
(43) Pub. Date: Dec. 11, 2014

(54) METHOD AND SYSTEM FOR IMPROVING PREDICTION IN ONLINE GAMING

(71) Applicant: Yosef MIZRACHI, Alfey Menashe (IL)

(72) Inventor: Yosef Mizrachi, Alfey Menashe (IL)

(21) Appl. No.: 14/368,804

(22) PCT Filed: Jan. 31, 2013
(86) PCT No.: PCT/IB2013/050843

§ 371 Date: Jun. 26, 2014

Related U.S. Application Data
(60) Provisional application No. 61/593,391, filed on Feb. 1, 2012.

(51) Int. Cl. G06N 99/00; H04L 29/06; G06N 5/04

(52) U.S. Cl. CPC G06N 99/005; G06N 5/047; H04L 67/42
USPC 706/14; 706/48

(57) ABSTRACT

A method and system for improving prediction, such as for online gaming, the method including the steps of: sampling values received from at least one sensor, over time; comparing the sampled values to at least one predefined pattern of sensor values; and identifying a set of sampled values at least partially matching at least one of the predefined patterns, wherein the sampled sensor values correspond, at least partially, to non-command-input related movement sensed by at least one sensor, and wherein the predefined pattern of sensor values is expected to precede a given command input.

### FIELD AND BACKGROUND OF THE INVENTION

The present invention relates to prediction for online gaming, monitoring, simulation (simulators) and other applications, more particularly, to a method and system for improving prediction based on pre-input movements, gestures, routines etc., which ‘telegraph’ the user's intentions and can be used to predict a user's actions before the user actually performs the action or finishes performing the action.

A ‘game controller’ is a device used with games or entertainment systems to provide input to a video game, typically to control an object or character in the game. A controller is usually connected to a game console or computer by means of a wire or cord, although wireless controllers are also widespread. Input devices that have been classified as game controllers include keyboards, mice, game pads, joysticks, etc. Special purpose devices, such as steering wheels for driving games and light guns for shooting games, are also game controllers.

A ‘video game console’ is an interactive entertainment computer or customized computer system that produces a video display signal which can be used with a display device (a television, monitor, etc.) to display a video game.

A ‘human interface device’ (HID) is a type of computer device that interacts directly with, and most often takes input from, humans and may deliver output to humans.

Generally, games consist of a looped sequence of states, or “frames”. During each frame, the game accepts user input and performs necessary calculations (AI, graphics etc.). When all processing is finished, the game will update the game state and produce an output, for example in the form of a new image on the screen and/or a packet to be sent to the server. The frequency at which frames are generated is often referred to as the frame rate.

In online gaming, ‘flag’ is a noticeable delay between the action of players and the reaction of the server. Although lag may be caused by high communication latency, it may also occur due to insufficient processing power in the client and/or server and/or a non-optimized configuration on the server and/or any end user device. Furthermore, latency is not constant but rather fluctuates resulting in a phenomenon known as “jitter”. The most commonly used solution for dealing with jitter is to create a bigger buffer so that the system has more time to run smoothing algorithms to smooth the game. The result of a bigger buffer is that there is added latency, but at least the latency is constant.

The tolerance for overall lag (all parts of latency and buffer to mitigate jitter) depends heavily on the type of game. For instance, a strategy game or a turn-based game with a low pace may have a high threshold or even be mostly unaffected by high delays, whereas a ‘twitch gameplay’ game such as a first-person shooter with a considerably higher pace may require significantly lower delay to be able to provide satisfying gameplay.

Solutions and Lag Compensation

There are Various Methods for Reducing or Disguising Delays:

Client-Side

As clients are normally not allowed to define the main game state, but rather receive it from the server, the main task of the client-side compensation is to render the virtual world as accurately as possible. As updates come with a delay and may even be dropped, it is sometimes necessary for the client to predict the flow of the game. Since the state is updated in discrete steps, the client must be able to estimate a movement based on available samples.

‘Client-side prediction’ can therefore be defined as a network programming technique used in video games intended to conceal negative effects of high latency connections. The technique attempts to make the player input feel more instantaneous while governing the player actions on a remote server. Two basic methods can be used to accomplish this: extrapolation and interpolation.

Extrapolation is an attempt to estimate a future game state. As soon as a packet from the server is received, the position of an object is updated to the new position. Awaiting the next update, the next position is extrapolated based on the current position and the movement at the time of the update. Essentially, the client will assume that a moving object will continue in the same direction. When a new packet is received, the position may be corrected slightly.

Interpolation works by essentially buffering a game state and rendering the game state to the player with a slight, constant delay. When a packet from the server arrives, instead of updating the position of an object immediately, the client will start to interpolate the position, starting from the last known position. Over an interpolation interval, the object will be rendered moving smoothly between the two positions. Ideally this interval should exactly match the delay between packets, but due to loss and variable delay, this is rarely the case. Both methods have advantages and drawbacks.

Interpolation ensures that objects will move between valid positions only and will produce good results with constant delay and no loss. Should dropped or out-of-order packets overflow the interpolation buffer the client will have to either freeze the object in position until a new packet arrives, or fall back on extrapolation. The downside of interpolation is that it causes the world to be rendered with additional latency, increasing the need for some form of lag compensation to be implemented.

The problem with extrapolating positions is fairly obvious: it is impossible to accurately predict the future. It will render movement correctly only if the movement is constant, but this will not always be the case. Players may change both speed and direction at random. This may result in a small amount of “warping” or “snapping” as new updates arrive and the estimated positions are corrected, and also cause problems for hit detection as players may be rendered in positions they are not actually in.

Often, in order to allow smooth gameplay, the client is allowed to do soft changes to the game state. While the server may ultimately keep track of ammunition, health, position etc., the client may be allowed to predict the new server-side game state based on the player's actions, such as allowing a player to start moving before the server has responded to the command. These changes will generally be accepted under normal conditions and make delay mostly transparent. Problems will arise only in the case of high delays or losses, when the client predictions are very noticeably undone by the server. Sometimes, in the case of minor differences, the server may even allow “incorrect” changes to the state based on updates from the client.

Server-Side

Unlike clients the server knows the exact current game state, and as such prediction is unnecessary. The main purpose of server-side lag compensation is instead to provide accurate effects of client actions. This is important because by the time a player's command has arrived time will have moved on, and the world will no longer be in the state that the player saw when issuing their command. A very explicit example of this is hit detection for weapons fired in first-person shooters, where margins are small and can potentially cause significant problems if not properly handled.

Until now, client-side prediction, as well as any other prediction solution, has been confined to predicting, based on user input and on the movements of the game's objects based on their velocities and accelerations, what the state of the game will be at the server when the update from the player input finally arrives at the server, and presenting the game in that state to the player. In other words, the player's client system reacts locally to the user input before the server has acknowledged the input and has updated the game state it is done to the predicted game state.

In other server-client game formats, the server does all calculations and sends the predicted state to the player. These predictions also are based on client commands and on game engine routines.

It would be highly advantageous to have a method and system for predicting the user's intentions rather than the user's actual input or at least before the user has completed entering the user input.

### SUMMARY OF THE INVENTION

The present invention effects a further mitigation of latency/lag by predicting and effecting player input before the player actually provides the input or finishes providing the input.

According to the present invention there is provided a method for improving prediction, such as for online gaming, the method including the steps of: sampling values received from at least one sensor, over time; comparing the sampled values to at least one predefined pattern of sensor values; and identifying a set of sampled values at least partially matching at least one of the predefined patterns, wherein the sampled sensor values correspond, at least partially, to non-command-input related movement sensed by at least one sensor, and wherein the predefined pattern of sensor values is expected to precede a given command input.

According to further features in preferred embodiments of the invention described below the method further including the step of: sending the identified set of sampled values to a central prediction unit.

According to still further features in the described preferred embodiments the method further includes the step of: evaluating a level of probability that the identified set of sampled values will precede the given command input; and sending the identified set of sampled values together with the evaluated probability level to a central prediction unit; or creating a prediction state based at least in part on the identified set of sampled values and the probability level.

According to still further features, the central prediction unit is located on a remote server or on a client-side device.

According to still further features, the method further includes the step of updating a pre-defined pattern of sensor values based on relevant sampled sensor values

According to still further features, the predefined pattern further includes sensor values corresponding to a sequence of at least some said command input.

According to still further features, the method further includes the step of identifying a sequence of sampled values corresponding to command input matching a pre-defined pattern.

According to still further features, the method further includes the step of creating a unique profile for a user based on sampled sensor values sensed prior to the user effecting a given command input.

According to another embodiment there is provided a client-side system for improving prediction, the system including: (a) a Human Input Device (HID) for receiving command input from a user; (b) at least one sensor, configured to sense) movement of the user; and (c) an application logic adapted to receive and process sensor values from the at least one sensor, and send prediction data based on the sensor values to a central prediction unit, wherein the received sensor values are compared to at least one predefined pattern of sensor values corresponding to movement effected prior to inputting a said command input, and wherein sensor values matching, at least partially, the predefined pattern cause the application logic to send prediction data predicting a command input related to the matched predefined pattern, to the central prediction unit.

According to further features, the movement is at least partially non-command-input related movement.

According to still farther features, the central prediction unit is located on a remote server.

### BRIEF DESCRIPTION OF THE DRAWINGS

Various embodiments are herein described, by way of example only, with reference to the accompanying drawings, wherein:

FIG. 1 is a diagrammatic representation of sensed input sampled at regular intervals for processing.

FIG. 2 is a diagrammatic representation of the application sending identified preliminary patterns and probabilities together with actual player input commands sensed.

### DESCRIPTION OF THE PREFERRED EMBODIMENTS

The principles and operation of a prediction method and system according to the present invention may be better understood with reference to the drawings and the accompanying description.

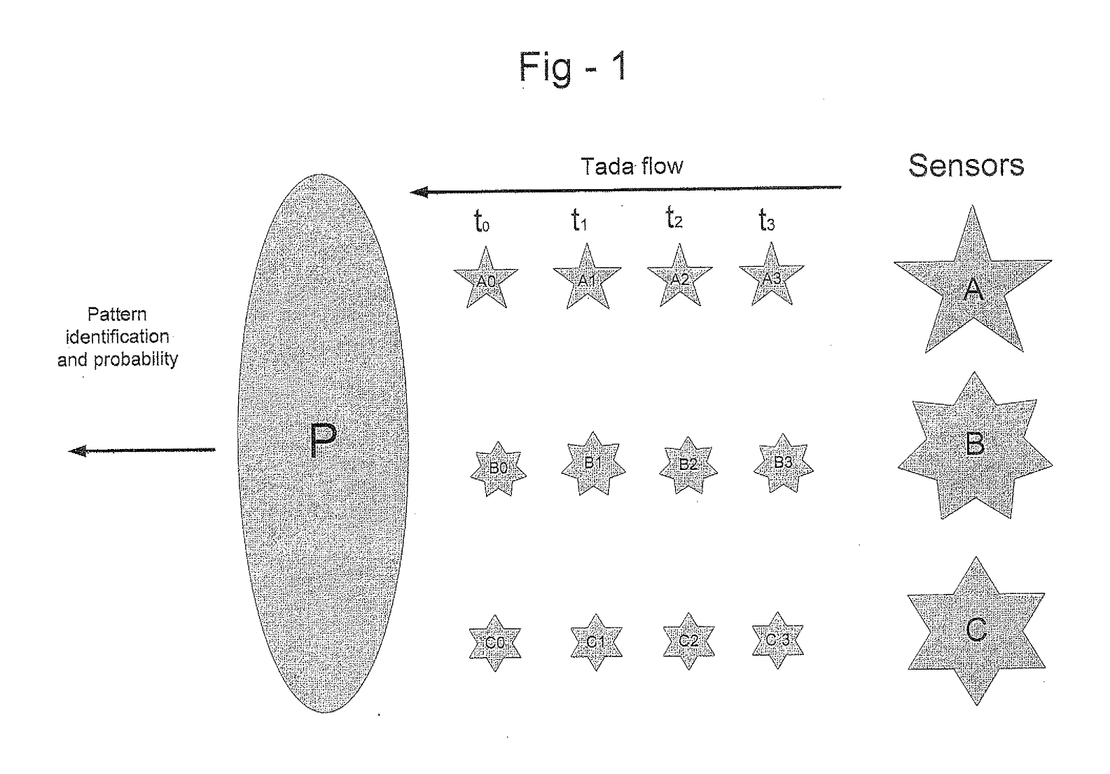

Referring now to the drawings, FIG. 1 illustrates a diagrammatic representation of sensed input sampled at regular intervals for processing. Players use input devices (HIDs) to enter game moves at their client systems. Examples of such input devices include a mouse or a joystick for interacting with a personal computer, and the touch screen of a tablet computer such as an iPad™. The process of entering a game move or command using such a device includes preliminary movement of some kind before the game move (or command) is actually entered. The preliminary moves or actions can be detected by one or another client-side mechanism (sensor) that can detect various kinds of player activities. For example, a player using a mouse needs to move the mouse so the cursor on the display screen is at the correct location and then click one of the mouse buttons to enter a game move. The translation and rotation of the mouse on the way to the correct location starts relatively fast and then slows down as the player gets the mouse closer to the desired location. The pressing of a mouse button is preceded by subtle vibrations of the mouse.

According to the present invention, a game application (generally located on the client device) learns the association between the player's movements, as sensed by the mouse or any other input device, and the resulting game move input, as the player begins to play the game. In some embodiments existing background sensors available on the playing device (such as an accelerometer), but not being used as defined input devices, can still run constantly in the background and collect data on an ongoing basis. This data can be used to validate user intentions. A game application can pre-define or get general patterns associated with the game's expected (available) activities.

A pre-defined pattern of non-command movement and/or command input sequences made by the player includes the acceptable deviations from the exact pattern values within the definition of the pattern (unless otherwise clear from the context). Therefore a general pattern of a preliminary movement which the user makes before inputting a command actually includes acceptable deviations from that pattern, within acceptable (and pre-defined) parameters. The deviations may be for example with regards to the values (e.g. values that are not simply 1 or 0 but rather a given number can be ‘off’ by plus or minus 2 or 3 and the like) or the fact that only some of the values of the pattern are present whilst others are not and so forth.

A local game application will learn player activities and redefine the general pattern to match the player's actual behavior. When the game application has learned the player's mouse movement quirks with sufficient accuracy to predict, on the order of hundreds of milliseconds before the player actually enters a game move, what that game move will be, forwarded to the central prediction unit usually located on the gaming server. The ability to predict moves or commands may actually be more subtle. That is to say that over time, the likelihood that a given sequence will result in an expected action increases statistically. This information is then included in the general prediction process (computed by a central prediction unit located either on a remote game server or on the local client-side application) as an additional source of information, but not an absolute certainty. In other embodiments, the client-side application can be a stand-alone module that bases prediction solely on the preliminary movement or pattern.

According to the current invention, values measured by sensors A, B, C (e.g. accelerometer, camera, etc.) of the input mechanisms (HIDs) are sampled periodically or due to a trigger event. The sampled values are processed (P) to find a pattern that corresponds to a pre-defined preliminary sequence that is expected to result or terminate in a user inputting a command L into the game.

At a point in time of t0, values A0, B0 and C0 are sent for processing P. At time t1 values A1, B1, C1 are sent for processing P and so on.

TABLE 1.1
Example 1

| | Sensor | | |
|---|---|---|---|
| Time | A | B | C |
| t0 | 1 | 0 | 0 |
| t1 | 0 | 0 | 1 |
| t2 | 1 | 1 | 1 |
| t3 | 0 | 1 | 1 |

| | |
|---|---|
| t4 | Player will enter command L |

Table 1.1 includes an exemplary pattern/template that has a sequence of values that matches user command L. When the sequence of values over time periods t1-t3 are measured then at time period t4 the player is expected/predicted to enter command L.

In some instances values from some of the sensors have relevance only some of the time. See Example 2-Table 1.2.

TABLE 1.2
Example 2

| | Sensor | | |
|---|---|---|---|
| Time | A | B | C |
| t0 | 1 | 0 | 0 |
| t1 | 0 | — | 1 |
| t2 | 1 | — | 1 |
| t3 | — | 0 | 1 |

| | |
|---|---|
| t4 | Player will enter command V |

If the values collected over time match, then it is expected with increasing likelihood that the player will input command L at time t4. The aforementioned data is sent by the client side application to the central prediction unit, which is usually located on the main game server.

The server prediction unit will give greater [statistical] importance to preliminary processes as the player affirms a preliminary process again and again over time. When there are several patterns that have identical initial stages it is not always possible to decide which is the real/correct process early on. There is a need to take into consideration additional data such as the exact status of the game and relevant commands or actions for this step. The client side application can send the data “as is” and specify the match to two preliminary processes as well as how likely each of the possibilities is —if it is possible to quantify such an attribute.

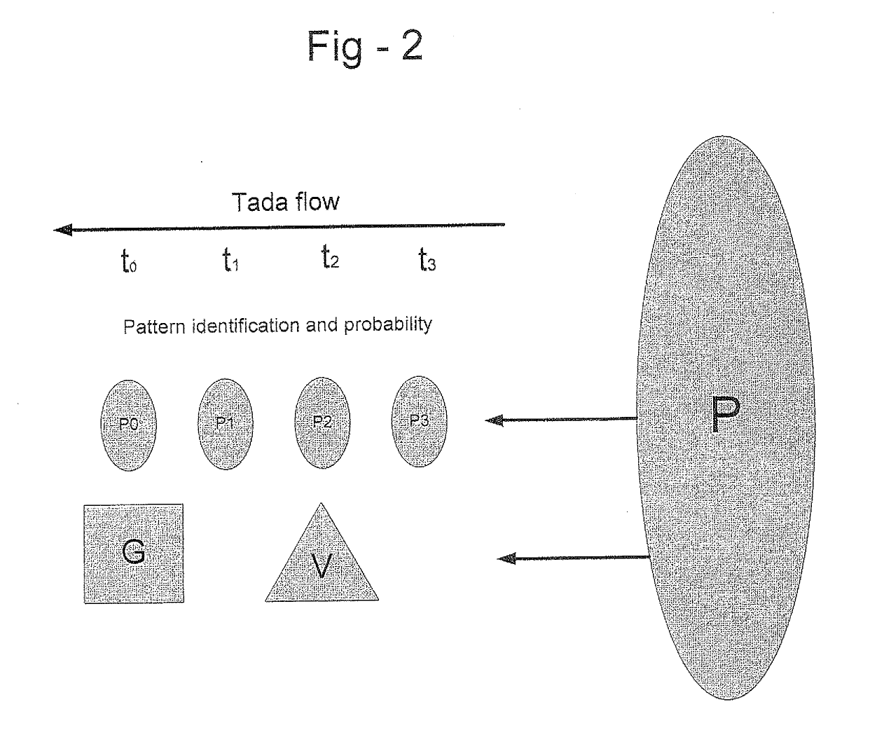

FIG. 2 illustrates a diagrammatic representation of the application sending identified preliminary patterns and probabilities together with actual player input commands sensed.

The predicted game move(s) (e.g. P0, P1, P2, P3) is sent to the server immediately (i.e. respectively at time periods t0, t1, t2 or t3) with all the game commands (e.g. V and G). The predicted game move (P0-P3) is sent together with the level of likelihood (i.e. probability) that the prediction will be accurate. It is expected that P0, P1, P2, and P3 will predict the same command or move, only that each subsequent prediction has an increasing probability of being accurate. For example, if a pattern includes fifteen values, then after the first three values are sampled a first prediction (P0) is sent, then after the next three values are sampled (so far six values in total that match the pre-defined pattern) a second prediction (P1) is sent, where the second prediction has a higher probability than the first. At the next interval three more values that match the next three values of the pattern are sampled and the third prediction (P2) (including nine values matching the pattern) will have an even higher probability than either P0 or P1. However predictions can be changed if the collected data no longer matches the same pattern. The server runs the game according to the game's updated commands and uses the predicted game move as additional information to create the predicted state of the game. When the actual game move arrives at the server, the game state is updated accordingly like any other game command. If the actual game move is not the same as the predicted game move then the new prediction will be updated. This unexpected prediction view can create a jump in the game view. Mitigation mechanisms will improve the view if it is not harmful to the game logic. Mitigation mechanisms can reside on the server side as well as on the client device.

In the embodiment in which the server does all games' calculations, client applications will send to the server the players' actual game moves and commands as well as indications of intentions to act (which indications could even include probabilities of two or more different indicated game moves and the timing of those game moves, as computed by the clients). The server calculates the game's logic based on the actual game commands and moves. To overcome latency in the whole process, the server also creates a predicted state of the game for clients' presentation based on the updated game world/state that also takes into consideration the information the server receives concerning players' intentions.

Another example, in the case of a game played via the touch screen of a tablet computer, the input is by touching the touch screen, and most of the preliminary movement, as the player's finger approaches the desired point on the touch screen, cannot be sensed via the touch screen until the player's finger actually contacts the touch screen. If, like the iPad™, the tablet computer includes an accelerometer, the primary input for the prediction of the player's move comes from the accelerometer. If, like the iPad 2™, the tablet computer includes a camera, further input for predicting the player's move comes from the camera using an application that detects objects' movements in the space.

In a further example, in the case of a central gaming engine with players connected over a network, where the game is played via a wireless controller (possibly paired to a gaming consol), players send commands to the server at regular intervals which are typically equal to the frame rate of the game. In the innovative system sends both user commands as well as indications of intentions of the player. Wireless controllers/gaming consoles are configured to sense a plethora of user indications and identify predefined commands. The immediate application also processes the sensor information that was not identified as command inputs, in order to identify preliminary indications of what the player's next move/command will be. The application/mechanism is able to identify such preliminary indications by comparing the sensed data with templates or patterns of predefined preliminary processes which precipitate particular player input, actions or commands. When such a pattern is recognized, the application sends the data which includes the type of pattern, the location of intended action on the game timeline and the pace of the game in order to properly calculate when the pattern will be realized by the player inputting the actual command and what the probability of that action being performed actually is.

The game server computes the game states as well as predictions for the players and takes into account the new information regarding the preliminary processes and the affect this information/data has on some or all of parameters of the game. The server then creates a game prediction in order to allow all the players a consistent prediction state which is also a more accurate prediction although not a perfect prediction. The immediate identification process provides a higher level of accuracy for predictions over a longer period of time.

Ability to improve predictions allows the player system/mechanism/application to increase the data buffer size so that the application stores more than the minimum data required, allowing the server to send corrective information when it detects errors in forecasting. Prediction correction then takes place on the player device and, in addition, a process of interpolation will take place in order to correct the incorrect data in the buffer and run smoothing algorithms on the data so that the player will play on the most accurate prediction state possible, and the picture will be smooth and not jumpy.

Preferably, the predicted game state that the server computes for overcoming the whole or part of the latency is based on the player's intention, as computed by the client/s that is sent as final analyzed data to the server in addition to the games' movements and commands and game logic. Less preferable, because of the large volume of data that would have to be sent, is having the client send raw detected data to the server and having the server calculates the player's intention. Sending all raw sensors' data to the server for processing is undesirable as the sheer volume of data to be transmitted—especially from multi-sensor input devices—is likely to significantly increase lag (as well as the amount of data-packets dropped or otherwise lost in transmission) even with large band-width connections with dedicated lines.

This innovation can be used as the only prediction process or in combination with another or other prediction solutions.

This innovation, though not 100% accurate, improves prediction correctness by collecting additional data to analyze and predict users' intentions, without waiting just for the users' game commands and/or game movements. This solution can be very good for few hundreds of milliseconds. Most fast reacting human activities can be observed and redefined, as they are very similar for most people.

In an additional exemplary configuration of the system, an, external sensor or sensors, such as a dedicated device which is in contact with the Game Server, can feed a separate stream of data, such as from a camera, an ultrasonic sensor, an IR sensor, microphone, heat sensor, etc., which is processed on, the server side. The external devices may or may not be coupled to the input device with which the user is playing the game.

The external sensors can take into account any local information which can influence user input directly or indirectly (e.g. sensing a pet distracting the user, whether the user is sitting up or laying down or sensing an increase heart rate or blood pressure etc.). Further sensed information such as whether the user is alone in the room or has company (friends, significant others, Children) can all or in part be taken into account and provide “psychological” information in addition to the physiological information mentioned previously. Potentially, the aforementioned sensor data processing of non-command movements can be effectively implemented in Augmented Reality or Virtual Reality uses.

A set of game commands and/or moves can be defines as a pattern which predictes a game action (command/s or move/s or any combination thereof)

In some embodiments of the system, pattern information is gathered by the system from users. The pattern information can be analyzed or otherwise used to update the pre-defined patterns (i.e. redefine the general patterns) and/or create new general patterns. This function can be effected by a learning application of a module stored in non-volatile storage.

In general, the system and application logic, whether client-side or server side, can be implemented on hardware, software, firmware or a combination thereof. The software or firmware is stored in a non-volatile memory and that is executed by a suitable instruction execution system as is well known in the art.

In a further embodiment, when the game application has learned the player's mouse movement quirks, other non-command movement patterns, or sequences of command inputs and/or non-command movements that are unique to the individual player, the prediction data can be used in other ways. For example, the non-command movement patterns and/or input command sequences that are unique to a player can be used as a unique profile that is used to verify that the individual currently playing is in fact the identified user. This process can be used as a security verification mechanism and the like in other areas whether user identification is needed.

Modern game consoles sense partial and complete movements and translate these movements into commands. The consoles do not recognize movements which are not part of an action/command input movement. The immediate invention senses to movements which “telegraph” what the next movement or action will be—even before the action has begun, or at least before the action is completed.

Even though the above discussion has focused on prediction within the framework of online gaming, it must be appreciated that the immediate invention can be likewise applied to monitoring systems, simulators, remote interactions that near instantaneous responses (e.g. remote flying of aircraft and the like) and any other application whereby sensor data can be used to predict future activities based on movements other than the actions themselves—whether the movements be prior to the action or after the action. (For example, one can predict how cricket ball will behave based on the movement of the bowler after the ball has left his hand.)

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for improving prediction, the method comprising the steps of:
(a) Sampling values received from at least one sensor, over time;
(b) Comparing said sampled values to at least one predefined pattern of sensor values; and
(c) Identifying a set of said sampled values at least partially matching said at least one pre-defined pattern,
Wherein said sampled sensor values correspond, at least partially, to non-command-input related movement sensed by said at least one sensor,
Wherein said predefined pattern of sensor values is expected to precede a given command input.

2. The method of claim 1, further comprising the step of:
(d) Sending said identified set of sampled values to a central prediction unit.

3. The method of claim 1, further comprising the step:
(d) Evaluating a level of probability that said identified set of sampled values will proceed said given command input.

4. The method of claim 3, further comprising the step:
(e) Sending said identified set of sampled values, together with said evaluated probability level, to a central prediction unit.

5. The method of claim 4, wherein said central prediction unit is located on a remote server.

6. The method of claim 4, wherein said central prediction unit is located on a client-side device.

7. The method of claim 3, further comprising the step of:
(e) Creating a prediction state based at least in part on said identified set of sampled values and said probability level.

8. The method of claim 1, further comprising the step of:
(d) Updating a said pre-defined pattern of sensor values based on relevant sampled sensor values.

9. The method of claim 1, wherein said predefined pattern further includes sensor values corresponding to a sequence of at least some said command input.

10. The method of claim 1, further comprising the step of:
(d) Identifying a sequence of said sampled values corresponding to command input matching a said pre-defined pattern.

11. The method of claim 1, further comprising the step of:
(d) creating a unique profile for a user based on sampled sensor values sensed prior to said user effecting a said given command input.

12. A client-side system for improving prediction, the system comprising:
(a) a Human Input Device (HID) for receiving command input from a user;
(b) At least one sensor, configured to sense movement of said user; and
(c) An application logic adapted to receive and process sensor values from said at least one sensor, and send prediction data based on said sensor values to a central prediction unit,
wherein said received sensor values are compared to at least one predefined pattern of sensor values corresponding to movement effected prior to inputting a said command input, and
Wherein sensor values matching, at least partially, a said predefined pattern cause said application logic to send prediction data predicting a command input related to said matched predefined pattern, to said central prediction unit.

13. The system of claim 12, wherein said movement is at least partially non-command-input related movement.

14. The system of claim 12, wherein said central prediction unit is located on a remote server.

15. A method for improving prediction, the method comprising the steps of:
(a) Sampling values received from at least one sensor, over time;
(b) Calculating values from said sampling values;
(c) Comparing said calculated values to at least one predefined pattern of values; and
(d) Identifying a set of said calculated values at least partially matching said at least one pre-defined pattern,
Wherein said at least one predefined pattern of values is expected to precede a given command input.

16. The method of claim 15, wherein said at least one predefined pattern of values includes values selected from the group consisting of: said sampled values, said calculated values and a combination of said sampled and said calculated values.

17. A method for improving prediction, the method comprising the steps of:
(a) sampling values received from at least one sensor, over time, said sampled sensor values corresponding, at least partially, to non-command-input related movement sensed by said at least one sensor; and
(b) Predicting a command-input based on said sampled sensor values.

18. The method of claim 17, further comprising the steps of:
(c) calculating values from said sampled values, wherein said command-input is predicted based on said values calculated from said sampled sensor values, wherein said calculated values are included in at least one prediction processes effected by at least one prediction mechanism,
Wherein said at least one prediction process is selected from the group consisting of: a local process, a remote process, a partial process, a distributed process and a combination of at least some of said processes, and
Wherein said at least one prediction mechanism is selected from the group consisting of: a local mechanism, a remote mechanism, a partial mechanism, a distributed mechanism and a combination of at least some of said mechanisms.

19. The method of claim 18, wherein said calculation is based on a calculation mechanism selected from the group consisting of: Bayesian-like statistics and Kalman filter-like algorithms.

20. The method of claim 17, further comprising the step of:
(c) Receiving triggered values, based on said sampled values, wherein said triggered values are included in at least one prediction processes affected by at least one prediction mechanism,
Wherein said at least one prediction process is selected from the group consisting of: a local process a remote process a partial process a distributed process and a combination of at least some of said processes, and
Wherein said at least one prediction mechanism is selected from the group consisting of: a local mechanism a remote mechanism, a partial mechanism, a distributed mechanism and a combination of at least some of said mechanisms.

21. The method of claim 20, further comprising the step of:
(d) Calculating values based on said triggered values, wherein said calculated values or triggered values are included in at least one prediction processes affected by at least one prediction mechanism,
Wherein said at least one prediction process is selected from the group consisting of: a local process, a remote process, a partial process, a distributed process and a combination of at least some of said processes, and
Wherein said at least one prediction mechanism is selected from the group consisting of: a local mechanism, a remote mechanism, a partial mechanism, a distributed mechanism and a combination of at least some of said mechanisms.

22. (canceled)

23. (canceled)

24. (canceled)
